(19) United States
(12) Patent Application Publication
(10) Pub. No.: US 2009/0280393 A1
(43) Pub. Date: Nov. 12, 2009

(54) Membrane electrode assembly for fuel cell and manufacturing method thereof

(76) Inventors: Lee Ming-San, Kaohsiung City (TW); Chen Long-Jeng, Kaohsiung City (TW); Chen Ting-Huai, Kaohsiung City (TW)

Correspondence Address: TROXELL LAW OFFICE PLLC, SUITE 1404, 5205 LEESBURG PIKE, FALLS CHURCH, VA, 22041, US

(21) Appl. No.: 12/149,686

(22) Filed: May 6, 2008

(51) Int. Cl. H01M 4/86; B05D 5/12

(52) U.S. Cl. 429/41; 429/12; 427/115

(57) ABSTRACT

A membrane electrode assembly for fuel cell comprises an electrolyte layer and a first electrode structure. The electrolyte layer has a first surface and a second surface. The first electrode structure disposed on the first surface of the electrolyte layer has a patterned microstructure. The patterned microstructure can be applied for widely increasing a contacting area between fuel or oxidant and the reaction layer, thereby not only enhancing efficiency of fuel cell but also greatly lowering usage of catalyst capable of saving manufacturing cost.

### FIELD OF THE INVENTION

The present invention is generally relating to membrane electrode assembly for fuel cell, more particularly to a membrane electrode assembly with a patterned microstructure.

### BACKGROUND OF THE INVENTION

Referring to FIG. 1, a known membrane electrode assembly (MEA) for fuel cell 10 mainly comprises an anode 11, a proton exchange membrane 12 and a cathode 13. The anode 11 and the cathode 13 respectively have a diffusion layer 14 and a catalyst layer 15, where the diffusion layer 14 is utilized for allowing the reactant gas to evenly and entirely diffuse and penetrate into the catalyst layer 15, the catalyst layer 15 is utilized for catalyzing electrochemical reaction within the fuel cell. However, a contacting area between the catalyst layer 15 and the diffusion layer 14 for the known structure is too small, so the speed of that fuel or oxidant (such as methanol molecule, H2, O2 etc.) passes through the catalyst layer 15 becomes slow that affects electrochemical reaction rate. Besides, since the passage of known catalyst layer 15 is narrow, generally narrower than mean free path of molecule, when fuel or oxidant just now infuse into the catalyst layer 15, they react immediately unable to penetrate into the catalyst layer 15 that results in waste of catalyst for low utilization rate.

### SUMMARY

The primary object of the present invention is to provide a MEA for fuel cell and manufacturing method thereof. The MEA for fuel cell comprises an electrolyte layer and a first electrode structure. The electrolyte layer has a first surface and a second surface and the first electrode structure disposed on the first surface of the electrolyte layer has a patterned microstructure. The present invention applies the patterned microstructure for widely increasing a contacting area between fuel or oxidant and the reaction layer, thereby not only enhancing efficiency of fuel cell but also greatly lowering usage of catalyst capable of saving manufacturing cost.

A MEA for fuel cell in accordance with the present invention comprises an electrolyte layer and a first electrode structure, in which the electrolyte layer has a first surface and a second surface, the first electrode structure disposed on the first surface of the electrolyte layer has a patterned microstructure.

An electrode structure of MEA in accordance with the present invention comprises a diffusion layer and a reaction layer, in which the diffusion layer has a surface and the reaction layer formed on the surface of the diffusion layer has a patterned microstructure.

An electrode structure of MEA in accordance with the present invention comprises a diffusion layer and a reaction layer, in which the diffusion layer has a surface and a patterned microstructure formed on the surface, the reaction layer covers the surface of the diffusion layer and the patterned microstructure.

A reaction layer of electrode structure in accordance with the present invention has a gas abundant layer, a catalyst layer and a patterned microstructure, in which the gas abundant layer has an upper surface, the patterned microstructure is formed on the upper surface of the gas abundant layer, the catalyst layer covers the patterned microstructure and the upper surface of the gas abundant layer.

A reaction layer of electrode structure in accordance with the present invention has a catalyst layer and a patterned microstructure formed on the catalyst layer.

A manufacturing method of membrane electrode assembly for fuel cell in accordance with the present invention comprises providing an electrolyte layer which has a first surface and a second surface and disposing a first electrode structure which has a patterned microstructure on the first surface of the electrolyte layer.

### DESCRIPTION OF THE DRAWINGS

FIG. 1 is a sectional view illustrating known membrane electrode assembly for fuel cell.

FIG. 2 is a sectional view illustrating a membrane electrode assembly for fuel cell in accordance with a preferred embodiment of the present invention.

FIG. 3 is a sectional view illustrating a membrane electrode assembly for fuel cell in accordance with an embodiment of the present invention.

FIG. 4 is a perspective view illustrating a plurality of columnar microstructures in array distribution in accordance with a preferred embodiment of the present invention.

FIG. 5 is a perspective view illustrating a plurality of columnar microstructures in array distribution in accordance with an embodiment of the present invention.

FIG. 6 is a perspective view illustrating a patterned microstructure denting on a gas abundant layer in accordance with another embodiment of the present invention.

FIG. 7 is a perspective view illustrating the patterned microstructure denting on the gas abundant layer in accordance with a further embodiment of the present invention.

FIG. 8 is a sectional view illustrating a membrane electrode assembly for fuel cell in accordance with another embodiment of the present invention.

FIG. 9 is a sectional view illustrating a membrane electrode assembly for fuel cell in accordance with another preferred embodiment of the present invention.

FIGS. 10A-10C is a flow diagram illustrating manufacturing method of a membrane electrode assembly for fuel cell in accordance with a preferred embodiment of the present invention.

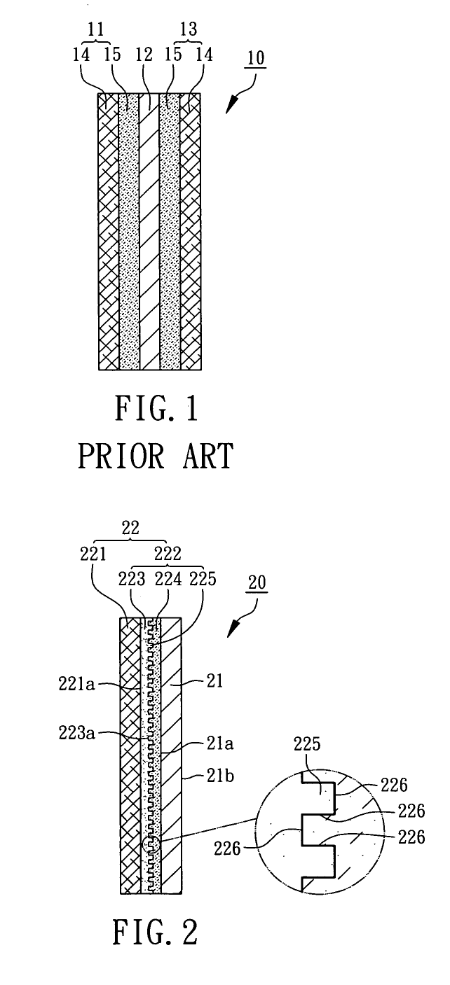

### DETAILED DESCRIPTION OF THE INVENTION

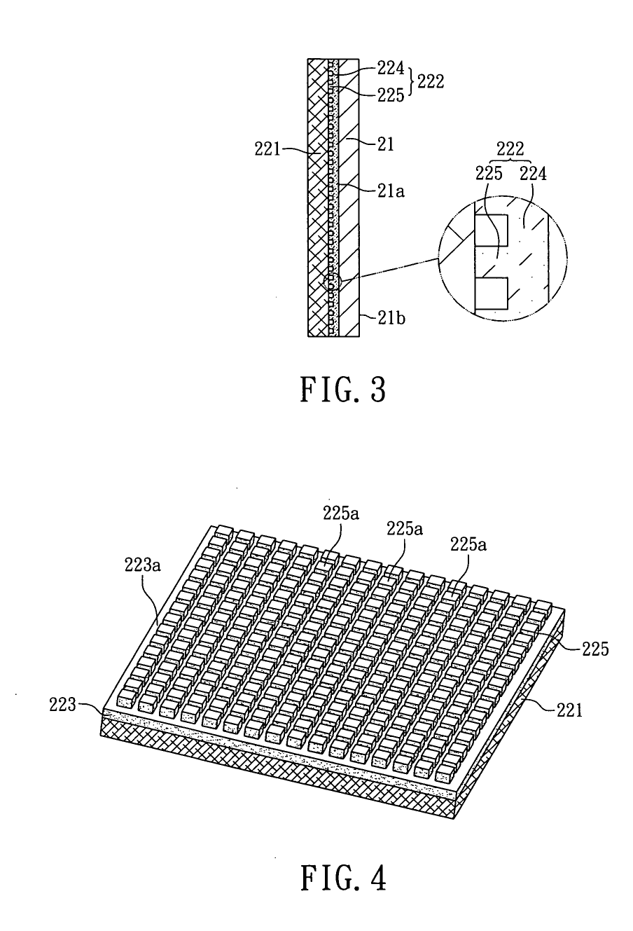

Referring to FIG. 2, a membrane electrode assembly (MEA) for fuel cell 20 in accordance with a preferred embodiment of the present invention comprises at least an electrolyte layer 21 and a first electrode structure 22. Commonly used electrolyte layer 21 can adopt proton exchange membrane or ion exchange membrane. The electrolyte layer 21 has a first surface 21a and a second surface 21b. The first electrode structure 22 disposed on the first surface 21a of the electrolyte layer 21 has a diffusion layer 221, a reaction layer 222 and a patterned microstructure 225. The diffusion layer 221 can be made of carbon cloth or carbon paper. The reaction layer 222, which is disposed between the diffusion layer 221 and the electrolyte layer 21 for performing electrochemical reaction, has a gas abundant layer 223 and a catalyst layer 224. In this embodiment, the patterned microstructure 225 is formed on the gas abundant layer 223 of the reaction layer 222 as to increase electrochemical reaction area. The gas abundant layer 223 can be made of carbon powder, carbon fiber, graphite powder, graphite fiber or other conductive material and has an upper surface 223a to form the patterned microstructure 225. Preferably, the gas abundant layer 223 is made of same material with the patterned microstructure 225 and can be formed integrally with the patterned microstructure 225 for reducing manufacturing process. Referring again to FIG. 2, the catalyst layer 224 covers the patterned microstructure 225 and the upper surface 223a of the gas abundant layer 223 and whose thickness is preferably less than or equal to 100 microns. Otherwise, referring to FIG. 3, the reaction layer 222 in another embodiment has the catalyst layer 224 and the patterned microstructure 225 able to be formed on the catalyst layer 224 for saving manufacture of the gas abundant layer 223. It is preferable that the catalyst layer 224 is formed integrally with the patterned microstructure 225.

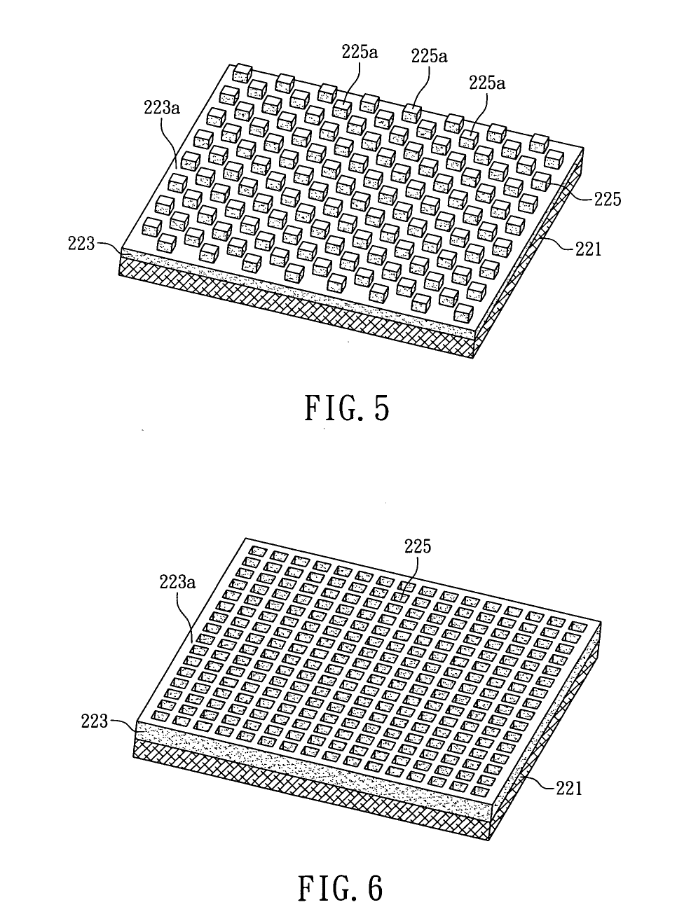

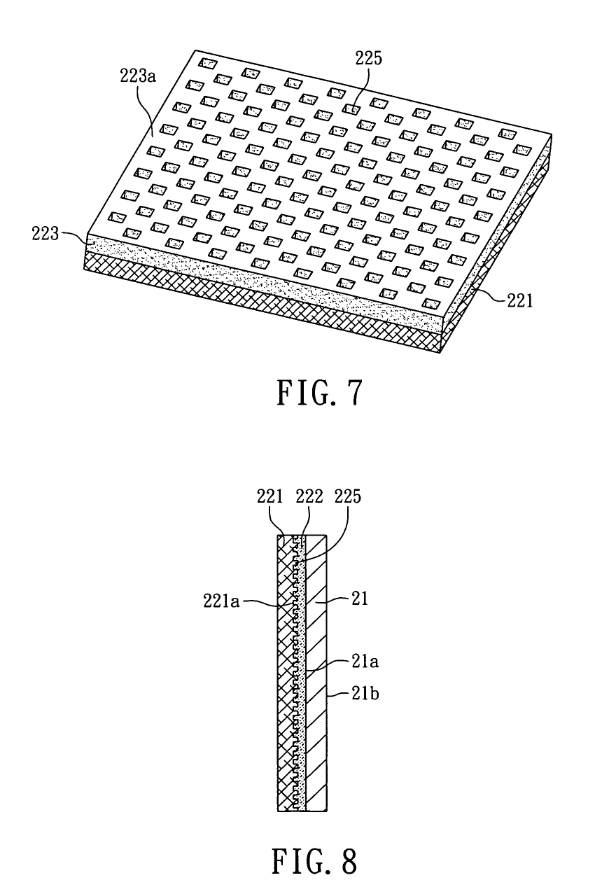

Referring again to FIG. 2, there is a reaction interface 226 between the gas abundant layer 223 and the catalyst layer 224 in this embodiment and which is composed of the upper surface 223a of the gas abundant layer 223 coverd by the catalyst layer 224 and the surface of the patterned microstructure 225. The size of the reaction interface 226 is typically regarded as that of the electrochemical reaction area. Referring to FIGS. 4 and 5, the patterned microstructure 225 can be composed of plural columnar microstructures 225a in array distribution and the interval among the columnar microstructures 225a can be either equal or unequal. Besides, the columnar microstructures 225a can be in shape of cylinder, long column, cone or other geometric form and is in shape of long column in this embodiment. The columnar microstructures 225a protrude from the upper surface 223a of the gas abundant layer 223, or referring to FIGS. 6 and 7, the patterned microstructure 225 can recess from the upper surface 223a of the gas abundant layer 223 in another embodiment.

As shown in FIG. 8, the patterned microstructure 225 in a further embodiment can be formed on the diffusion layer 221 and the diffusion layer 221 has a surface 221a. The patterned microstructure 225 is actually formed on the surface 221a of the diffusion layer 221 and preferably formed integrally with the diffusion layer 221. In this embodiment, the reaction layer 222 covers the surface 221a of the diffusion layer 221 and the patterned microstructure 225 and preferably is composed of catalyzing material.

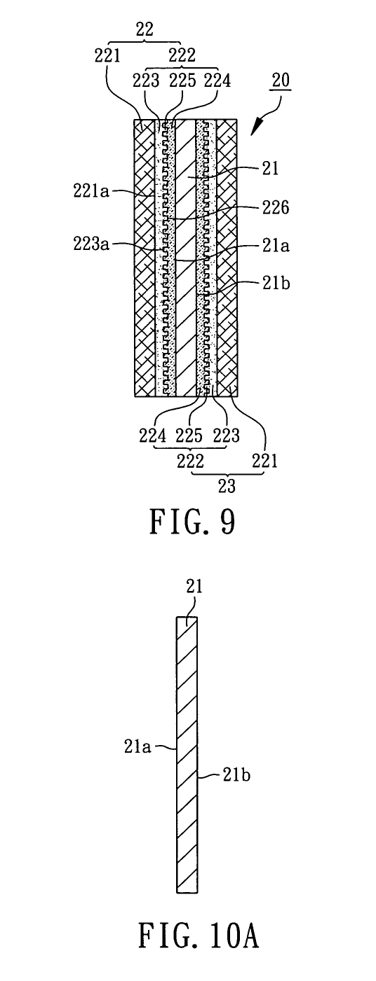

Referring to FIG. 9, the membrane electrode assembly for fuel cell 20 can further comprise a second electrode structure 23 disposed on the second surface 21b of the electrolyte layer 21. In this embodiment, the second electrode structure 23 is the same as the first electrode structure 22, where the first electrode structure 22 can function as either anode or cathode and polarity of the second electrode structure 23 is opposite to that of the first electrode structure 22, e.g., if the first electrode structure 22 functions as anode, and then the second electrode structure 23 functions as cathode.

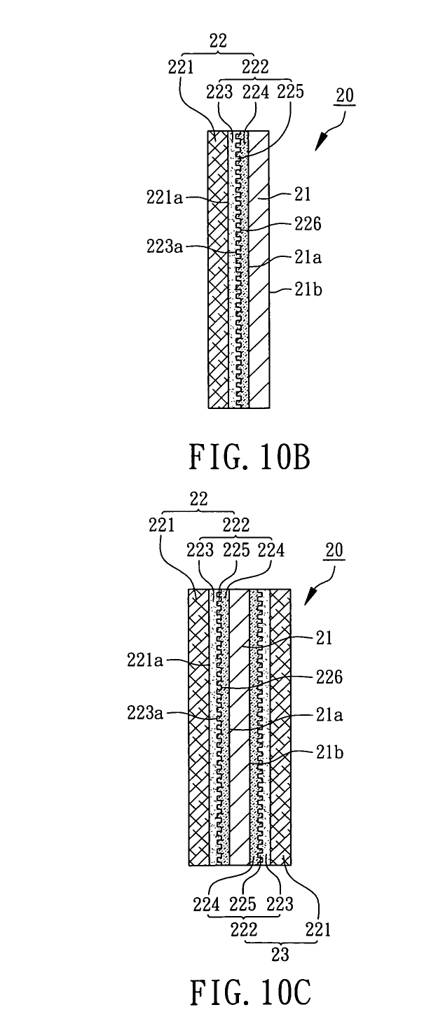

FIGS. 10A-10C illustrates manufacturing method of the membrane electrode assembly for fuel cell 20 and first referring to FIG. 10A, an electrolyte layer 21 is provided which has a first surface 21a and a second surface 21b. Commonly used electrolyte layer 21 in this embodiment can adopt proton exchange membrane or ion exchange membrane. Next referring to FIG. 10B, a first electrode structure 22 is disposed on the first surface 21a of the electrolyte layer 21, which has a diffusion layer 221, a reaction layer 222 and a patterned microstructure 225. The reaction layer 222, which is disposed between the diffusion layer 221 and the electrolyte layer 21 for performing electrochemical reaction, has a gas abundant layer 223 and a catalyst layer 224. In this embodiment, the patterned microstructure 225 is formed on the gas abundant layer 223 of the reaction layer 222 as to increase electrochemical reaction area. The gas abundant layer 223 can be made of carbon powder, carbon fiber, graphite powder, graphite fiber or other conductive material. The gas abundant layer 223 and the patterned microstructure 225 can be formed integrally or separately by wet etching, dry etching or micro printing a conductive material. The catalyst layer 224 covers the patterned microstructure 225 and the upper surface 223a of the gas abundant layer 223 and can be formed by means of deposing, electro spraying, transfer-printing or coating method. Moreover, referring to FIG. 10C, it further comprises disposing a second electrode structure 23 same as the first electrode structure 22 on the second surface 21b of the electrolyte layer 21 in this embodiment. Preferably, the membrane electrode assembly for fuel cell 20 is formed by thermal compressing the first electrode structure 22, the electrolyte layer 21 and the second electrode structure 23.

Accordingly, the present invention applies the patterned microstructure 225 for widely increasing a contacting area between fuel or oxidant and the reaction layer 222, thereby not only enhancing efficiency of fuel cell but also greatly lowering usage of catalyst capable of saving manufacturing cost.

While the present invention has been particularly illustrated and described in detail with respect to the preferred embodiments thereof, it will be clearly understood by those skilled in the art that various changed in form and details can be made without departing from the spirit and scope of the present invention.

What is claimed is:

1. A membrane electrode assembly for fuel cell comprising:
an electrolyte layer having a first surface and a second surface; and
a first electrode structure disposed on the first surface of the electrolyte layer and having a patterned microstructure.

2. The membrane electrode assembly for fuel cell in accordance with claim 1,
wherein the first electrode structure has a diffusion layer and a reaction layer disposed between the diffusion layer and the electrolyte layer.

3. The membrane electrode assembly for fuel cell in accordance with claim 2, wherein the patterned microstructure is formed on the reaction layer.

4. The membrane electrode assembly for fuel cell in accordance with claim 3, wherein the reaction layer has a gas abundant layer and a catalyst layer.

5. The membrane electrode assembly for fuel cell in accordance with claim 4, wherein there is a reaction interface between the gas abundant layer and the catalyst layer.

6. The membrane electrode assembly for fuel cell in accordance with claim 4, wherein a thickness of the catalyst layer is less than or equal to 100 microns.

7. The membrane electrode assembly for fuel cell in accordance with claim 3, wherein the reaction layer has a catalyst layer and the patterned microstructure is formed on the catalyst layer.

8. The membrane electrode assembly for fuel cell in accordance with claim 1, wherein the patterned microstructure is composed of plural columnar microstructures.

9. The membrane electrode assembly for fuel cell in accordance with claim 8, wherein the columnar microstructures are in array distribution.

10. The membrane electrode assembly for fuel cell in accordance with claim 1, wherein it further comprises a second electrode structure disposed on the second surface of the electrolyte layer.

11. The membrane electrode assembly for fuel cell in accordance with claim 10, wherein the second electrode structure is the same as the first electrode structure.

12. Manufacturing method of a membrane electrode assembly for fuel cell comprising:
providing an electrolyte layer, the electrolyte layer having a first surface and a second surface; and
disposing a first electrode structure on the first surface of the electrolyte layer, the first electrode structure having a patterned microstructure.

13. The manufacturing method of the membrane electrode assembly for fuel cell in accordance with claim 12, wherein the first electrode structure has a diffusion layer and a reaction layer disposed between the diffusion layer and the electrolyte layer.

14. The manufacturing method of the membrane electrode assembly for fuel cell in accordance with claim 13, wherein the patterned microstructure is formed on the reaction layer.

15. The manufacturing method of the membrane electrode assembly for fuel cell in accordance with claim 14, wherein the reaction layer has a gas abundant layer and a catalyst layer.

16. The manufacturing method of the membrane electrode assembly for fuel cell in accordance with claim 15, wherein a thickness of the catalyst layer is less than or equal to 100 microns.

17. The manufacturing method of the membrane electrode assembly for fuel cell in accordance with claim 14, wherein the reaction layer has a catalyst layer and the patterned microstructure is formed on the catalyst layer.

18. The manufacturing method of the membrane electrode assembly for fuel cell in accordance with claim 12, wherein the patterned microstructure is composed of plural columnar microstructures.

19. The manufacturing method of the membrane electrode assembly for fuel cell in accordance with claim 18, wherein the columnar microstructures are in array distribution.

20. The manufacturing method of the membrane electrode assembly for fuel cell in accordance with claim 12, wherein it further comprises disposing a second electrode structure on the second surface of the electrolyte layer, the second electrode structure is the same as the first electrode structure.
